(19) United States
(12) Patent Application Publication
(10) Pub. No.: US 2013/0216910 A1
(43) Pub. Date: Aug. 22, 2013

(54) HIGH CAPACITY ALLOY ANODES AND LITHIUM-ION ELECTROCHEMICAL CELLS CONTAINING SAME

(71) Applicant: Mark N. Obrovac, Halifax (CA)

(72) Inventor: Mark N. Obrovac, Halifax (CA)

(73) Assignee: 3M INNOVATIVE PROPERTIES COMPANY, St. Paul, MN (US)

(21) Appl. No.: 13/882,678

(22) PCT Filed: Oct. 31, 2011
(86) PCT No.: PCT/US11/58504

§ 371 Date: Apr. 30, 2013

Related U.S. Application Data
(60) Provisional application No. 61/411,653, filed on Nov. 9, 2010.

(51) Int. Cl. H01M 4/131; H01M 4/1395; H01M 4/1391; H01M 4/134; H01M 4/62

(52) U.S. Cl. CPC H01M 4/131; H01M 4/134; H01M 4/622; H01M 4/1391; H01M 4/1395
USPC 429/217; 429/209; 429/218.1; 429/223; 29/623.5

(57) ABSTRACT

A lithium-ion electro-chemical cell that includes a cathode that includes an electrochemically-active metal oxide coating on a first current collector, an electrolyte, and an anode that includes an electrochemically-active alloy coating on a second current collector. Both the anode and the cathode have a reversible capacity of greater than 4.5 mAh/cm² per coated side. The metal oxide coating typically comprises cobalt, manganese, nickel, or a combination thereof. The reversible capacity of the cathode is within 15% of the reversible capacity of the anode.

### FIELD

This disclosure relates to high density alloy anodes and lithium-ion electrochemical cells that contain such anodes.

### BACKGROUND

Lithium-ion electrochemical cells include a cathode, an anode, a separator, and an electrolyte typically enclosed in a cell can or container. The cathode and the anode can include a metal current collector and an electrode coating—usually deposited on both sides of the current collector. The electrode coatings include electrochemically active materials or materials that can electrochemically react with lithium to produce electrochemical energy when the cell is discharged and to store electrochemical energy when the cell is recharged.

Lithium-ion electrochemical cells are currently of great interest for use in electronic devices and vehicles since they have the ability to store large amounts of energy in relatively small volumes. There is a limit, however, to how much energy conventional lithium-ion electrochemical cells can provide.

### SUMMARY

A limiting factor for the energy capacity of a lithium-ion electrochemical cell is the capacity per unit area of the electrodes. This capacity is often called the electrode loading. In general, increasing the electrode loading will result in increased cell energy. This is because in lithium-ion electrochemical cells with high loadings, more volume is occupied by active materials and less volume is occupied by inactive cell components (such as the separator and current collector), compared with cells that use low loadings. For a given electrode material, the electrode loading can be increased by coating more electrode material on the current collector, which can increase coating thickness. There is a maximum amount or thickness of electrode material, or maximum tolerable value, of electrode material that can be used on each electrode in an electrochemical cell. High electrode loadings, for example those above the maximum tolerable value for the electrode, can make the electrode unmanageably thick so that the electrode may be too brittle to handle or too thick to wind into the case of a cylindrical cell design. In addition, the total thickness of the electrode coating may also be so large as to cause an unreasonable diffusion path length for lithium ions to travel and can severely reduce cell rate capacity.

For the above reasons, electrode loadings in typical lithium-ion electrochemical cells are limited to about 4 mAH/cm² per coated side. There is a need for electrodes that have loadings beyond this limit. There is also a need for lithium-ion electrochemical cells, which may have a fixed volume, to have higher energy capacities as the energy requirements of the devices they power increases.

In one aspect, a lithium-ion electrochemical cell is provided that includes a cathode that comprises an electrochemically-active metal oxide coating on a first current collector, an electrolyte, and an anode that includes an electrochemically-active alloy coating on a second current collector, wherein both the anode and the cathode have an electrode loading of greater than about 4.5 mAh/cm² per coated side. The electrochemically-active metal oxide coating can include cobalt, manganese, nickel, or a combination thereof. The electrochemically-active anode coating can include a binder such as lithium polyacrylate. The coating weight of the electrochemically-active metal oxide coating can be greater than about 30 mg/cm² and the coating weight of the electrochemically-active anode coating can be greater than about 15 mg/cm². The first charge capacity of the cathode can be within 15% or even within 10% of the first charge capacity of the anode.

In another aspect, a method of making a lithium-ion electrochemical cell is provided that includes providing a cathode and includes an electrochemically-active metal oxide coating on a first current collector, an anode that includes an electrochemically-active alloy coating on a second current collector, and an electrolyte and assembling the cathode, the anode, and the electrolyte to form an lithium-ion electrochemical cell, wherein the electrode loadings of both the cathode and the anode are greater than about 4.5 mAh/cm² per coated side.

In this disclosure:

“active” or “electrochemically-active” refers to a material in which lithium can be reversibly inserted and removed by electrochemical means;

“amorphous” refers to a material that lacks the long range atomic order characteristic of crystalline material, as determined using x-ray diffraction;

“anode” refers to the electrode where electrochemical oxidation occurs during the discharging process and is also referred to herein as the negative electrode;

“battery” refers to a plurality of electrochemical cells that are connected together, usually in parallel;

“cathode” refers to the electrode where electrochemical reduction occurs during the discharging process and is also referred to herein as the positive electrode;

“loading” or “electrode loading” refers to the amount of lithium that can be reversibly stored by an electrode and is typically expressed milliamp hours (mAh) per unit area; and

“volumetric capacity” refers to the amount of lithium stored per unit volume of an active material or coating.

The provided lithium-ion electrochemical cells have high reversible capacity that is provided by using electrochemically-active alloy anode materials that have a higher volumetric capacity than graphite. For such anodes, the coating thickness is smaller than conventional graphitic carbon electrodes with the same loading. As a result, significantly higher anode electrode loadings can be achieved. In particular, the provided electrochemical cells that include electrochemically-active alloy anodes with higher volumetric capacity than graphite can operate at loadings of greater than 4 mAh/cm² per coated side. Using electrochemically active alloy anode materials and electrochemically-active metal oxide cathode materials in the same electrochemical cell can result in the cells with high reversible capacity. Moreover, the anode coatings in these cells can be robust enough to handle and assemble into lithium-ion electrochemical cells despite their high loadings.

The above summary is not intended to describe each disclosed embodiment of every implementation of the present invention. The brief description of the drawings and the detailed description which follows more particularly exemplify illustrative embodiments.

### BRIEF DESCRIPTION OF THE DRAWINGS

FIG. 1 is a graph of the voltage (V) vs. capacity (mAh/g) for the exemplified lithium ion electrochemical cell.

### DETAILED DESCRIPTION

In the following description, reference is made to the accompanying set of drawings that form a part of the description hereof and in which are shown by way of illustration several specific embodiments. It is to be understood that other embodiments are contemplated and may be made without departing from the scope or spirit of the present invention. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

Lithium-ion electrochemical cells include a cathode, anode, separator, electrolyte and cell can or canister within which the other components mentioned above are contained. The volume of the lithium-ion electrochemical cells is thus defined and limited to the dimensions of the can or canister. The cathode and anode each include a metal current collector and an electrode coating, usually deposited on both sides of the current collector. The electrode coatings include electrochemically active materials (herein referred to as “active materials”). A polymeric binder and/or a conductive diluent can be added to the respective electrode coating to hold the electrode together, to bind or to adhere it to the current collector, and, in the case of the conductive diluent, to allow good conductivity of the electrode coating to the current collector.

There is a need for electrochemical cells that have high energy densities contained in small volumes. This is particularly true, for example, in the hand-held electronics industry where miniaturization of complex electronic devices is driving the market and in the emerging electric vehicle industry where high energy density in small fixed volumes is important. High energy-density cathode materials such as lithium cobalt dioxide are currently being employed in commercial lithium-ion batteries. These batteries can be used, for example, in cellular telephones and laptop computers. For an electrochemical cell of a fixed volume, when the coating thicknesses are increased, the amount of active materials in the cell is increased. Consequently, the amount of inactive components, such as current collectors, separators, etc. is decreased and thus, the energy stored in the cell increases as a function of the cell volume. The designed energy for an electrochemical cell can increase significantly if thick coatings are used in cell electrodes. Typically, the anode material utilized for high energy lithium-ion electrochemical cells is graphite.

One way to obtain higher electronic current densities in lithium-ion electrochemical cells can be to utilize thick coatings. Coating thickness for lithium-ion electrodes can be limited by a number of factors. Wound cells can have a coating thickness limitation due to the tendency for thick coatings to crack and peel off the current collector during the cell winding process. One solution to this problem can be to use laminar cell designs are used that do not require cell winding. However, such cell designs may be expensive and may not provide sufficient pressure on the electrode stack for optimum cell operation. Thick coatings can also result in a longer lithium diffusion path between the anode and the cathode. These factors can limit the rate capability of the cell. That is, electrodes with excessively thick coatings cannot be charged and discharged quickly.

The electrode coating thickness can also be limited by the coating manufacturing methods, which can require the coatings to be calendared. Thick coatings may need several calendar passes and can tend to extrude and or bounce back during the calendaring process.

For the above reasons, coatings are typically limited to have less than 4 mAh/cm² reversible capacity per side. That is less than about 27 mg/cm² cathode coating per side when using lithium metal oxides, such as lithium cobalt dioxide, and less than about 15 mg/cm² anode coating per side for conventional active materials. These loadings correspond to coating thicknesses of less than about 80 μm per side for both the cathode and the anode.

In order to design a higher energy-density electrochemical cell in a contained volume, anode materials can be utilized that have higher energy-densities than graphite. The provided electrochemical cells include anode coatings that comprise electrochemically active alloys having a higher volumetric capacity than graphite. Such alloy anode coatings can have greater than twice the energy density of conventional graphite electrodes. This results in electrochemical cells with significantly higher energy densities. Such anode coatings comprising electrochemically active alloy materials with conventional loadings can be half as thick as conventional graphite coatings with the same loading. Accordingly, alloy anodes with about double the loading of conventional graphite coatings can have coating thicknesses about equal to conventional graphite coatings. For a given cathode, this results in significantly shorter diffusion paths for lithium ions to travel from the anode to the cathode compared to if a conventional anode was used at the same loading. The provided electrochemical cells include electrochemically-active alloy anode coatings which can have electrode loadings of greater than about 4.5 mAh/cm² per side, greater than about 5.0 mAh/cm² per side, greater than about 6.0 mAh/cm² per side, greater than about 7.0 mAh/cm² per coated side, greater than about 8 mAh/cm² per coated side, or even higher loadings.

Electrodes can have an electrode coating on one side of the current collector or on both sides of the current collector. For electrodes that have an electrode coating on one side of a current collector, the electrode loading is the amount of lithium that is reversibly stored on the coated side of the electrode per unit area. For electrodes that have electrode coatings on both sides of a current collector (double-coated electrode), the loading is defined herein as the amount of lithium reversibly stored on one coated side of the electrode per unit area. For double-coated electrodes, the loading on either side of the electrode may be the same or may be different depending upon cell design.

The provided high energy-density lithium-ion electrochemical cells include a cathode that includes an electrochemically-active metal oxide coating on a first current collector. Representative positive electrodes include LiMn₂O₄, LiCoO₂; lithium transition metal oxides as disclosed in U.S. Pat. Nos. 5,858,324 (Dahn et al.), 5,900,385 (Dahn et al.), 6,143,268 (Dahn et al.); 6,680,145 (Obrovac et al.); 6,964,828 and 7,078,128 (both Lu et al.); 7,211,237 (Eberman et al.) 7,556,655; (Dahn et al.), U.S. Pat. Publ. No. 2004/0121234 and 2008/032185 (both Le); U.S. Pat. Publ. Nos. 2008/0280205, 2009/0087747, and 2010/0015516 (all Jiang et al.); and PCT Publ. No. WO 2009/120515 (Jiang).

In some embodiments, useful cathode compositions are those having the following formulae: Li[Li_{(1-2y)/3}Ni_{y}Mn_{(2-y)/3}]O₂;Li[Li_{(1-y)/3}Co_{y}Mn_{(2-2y)/3}]O₂; and Li[Ni_{y}Co_{1-2y}Mn_{y}]O₂. In one embodiment, x=(2-y)/3 and M¹₍₁₋ₓ₎ has the formula Li_{(1-2y)/3}M²_{y}, where 0<y<0.5 (typically 0.083<y<0.5 or 0.167<y<0.5) and M² represents one or more metal elements, with the proviso that M² is a metal element other than chromium. The resulting cathode composition has the formula Li[Li_{(1-2y)/3}M²_{y}Mn_{(2-y)/3}]O₂. In another embodiment, x=(2-2y)/3 and M¹₍₁₋ₓ₎ has the formula Li_{(1-y)/3}M³_{y}, where 0<y<0.5 (typically 0.083<y<0.5, or even 0.167<y<0.5) and M³ represents one or more metal elements, with the proviso that M³ is a metal element other than chromium. The resulting cathode composition has the formula Li[Li_{(1-y)/3}M³_{y}Mn_{(2-2y)/3}]O₂. In another embodiment, x=y and M¹₍₁₋ₓ₎ has the formula M⁴_{y}M⁵_{1-2y}, where 0<y<0.5 (typically 0.083<y<0.5, or 0.167<y<0.5), M⁴ is a metal element other than chromium, and M⁵ is a metal element other than chromium and different from M⁴. The resulting cathode composition has the formula Li[M⁴_{y}M⁵_{1-2y}Mn_{y}]O₂. Other exemplary metal oxide cathode materials can include the above-named materials that are somewhat oxygen deficient—in other words there may be less than two molar equivalents of oxygen present in these materials. These materials are described in U.S. Pat. No. 7,368,071 (Dahn et al). Examples of suitable metal elements for inclusion in the cathode composition include Ni, Co, Fe, Cu, Li, Zn, V, and combinations thereof. It is further contemplated than any metal oxides that include at least one of manganese, cobalt, or nickel can be utilized in the provided lithium-ion electrochemical cells. The lithium transition metal oxides are well known to those of ordinary skill in the art.

The provided high energy-density lithium-ion electrochemical cells include an anode that includes an electrochemically-active alloy coating on a second current collector. In one embodiment, the electrochemically-active alloy coating includes an electrochemically active phase that includes elemental silicon, elemental tin, or a combination of silicon and tin as well as an electrochemically-inactive phase that includes two or more metal elements. Examples of suitable metal elements include iron, aluminum, nickel, manganese, cobalt, copper, silver, and chromium, with iron, copper, and aluminum being typically utilized. These electrochemically-active alloy coatings are further disclosed, for example, in U.S. Pat. No. 7,498,100 (Christensen et al.).

Additional electrochemically-active alloy materials useful in the provided lithium-ion electrochemical cells can include an amorphous alloy composition that contains tin, silicon, a third element that includes yttrium, a lanthanide element, an actinide element, or a combination thereof, and an optional alkaline earth element, and an optional transition metal. The alloy can contain tin in an amount of 1 to 50 mole percent, the second element in an amount of 20 to 95 mole percent, the third element in an amount of 3 to 50 mole percent, and the optional transition metal in an amount of 0 to 1 mole percent based on a total number of moles of all elements except lithium in the alloy composition. Suitable transition metals include, but are not limited to, titanium, vanadium, chromium, manganese, iron, cobalt, nickel, copper, zirconium, niobium, molybdenum, tungsten, and combinations thereof. The optional alkaline earth element can include, for example, magnesium, calcium, barium, strontium, or a combination thereof. These useful electrochemically-active alloy materials are further disclosed, for example, in U.S. Pat. No. 7,767,349 (Obrovac et al.).

Other electrochemically-active alloy materials useful in the provided lithium-ion electrochemical cells can include silicon in an amount of 35 to 70 mole percent, aluminum in an amount of 1 to 45 mole percent, a transition metal in an amount of 5 to 25 mole percent, tin in an amount of 1 to 15 mole percent, and a fifth element that includes yttrium, a lanthanide element, an actinide element, or a combination thereof in an amount of 2 to 15 mole percent. Each mole percent is based on a total number of moles of all elements except lithium in the alloy composition. The alloy composition can be a mixture of an amorphous phase that includes silicon and a nanocrystalline phase that includes tin and the fifth element. Suitable transition metals include, but are not limited to, titanium, vanadium, chromium, manganese, iron, cobalt, nickel, copper, zirconium, niobium, molybdenum, tungsten, and combinations thereof. These useful silicon-containing alloy materials are further disclosed, for example, in U.S. Pat. Publ. No. 2007/0020521 (Obrovac et al.).

Other electrochemically-active alloy materials useful in the provided lithium-ion electrochemical cells include alloy compositions that contain silicon in an amount of 35 to 70 mole percent, aluminum in an amount of 1 to 45 mole percent, a transition metal in an amount of 5 to 25 mole percent, tin in an amount of 1 to 15 mole percent, indium in an amount up to 15 mole percent, and a sixth element that includes yttrium, a lanthanide element, an actinide element, or a combination thereof in an amount of 2 to 15 mole percent. Each mole percent is based on a total number of moles of all elements except lithium in the alloy composition. The alloy composition is a mixture of an amorphous phase that includes silicon and a nanocrystalline phase that includes tin, indium, and the sixth element. Suitable transition metals include, but are not limited to, titanium, vanadium, chromium, manganese, iron, cobalt, nickel, copper, zirconium, niobium, molybdenum, tungsten, and combinations thereof. These silicon-containing alloy anode coating materials are described, for example in U.S. Pat. Publ. No. 2007/0020522 (Obrovac et al.).

Additional electrochemically-active alloy materials useful in the provided lithium-ion electrochemical cells include alloys of tin. Useful electrochemically-active alloys of tin can include transition metals, such as iron or cobalt and can also include carbon. Useful tin-containing electrochemically active alloy materials are disclosed, for example, in U.S. Pat. Publ. No. 2006/0068292 (Nizutani et al.).

The current collector for the electrodes can be any material or combination of materials known in the art. For example, typical current collectors used in lithium-ion electrochemical cells include thin foils of conductive metals or alloys such as, for example, aluminum or aluminum alloys for the positive electrode (cathode), or first current collector, and copper, stainless steel, nickel, and combinations thereof for the negative electrode (anode) or second current collector. The foils can have a thickness of from about 5 to about 20 microns. In some embodiments, the first current collector can include aluminum that has two opposing sides and the second current collector can include copper foil and has two opposing sides.

The provided electrochemically-active metal oxide coating or electrically-active alloy anode coating can include a polymeric binder. Exemplary polymer binders include polyolefins such as those prepared from ethylene, propylene, or butylene monomers; fluorinated polyolefins such as those prepared from vinylidene fluoride monomers; perfluorinated polyolefins such as those prepared from hexafluoropropylene monomer; perfluorinated poly(alkyl vinyl ethers); perfluorinated poly(alkoxy vinyl ethers); or combinations thereof. Specific examples of polymer binders include polymers or copolymers of vinylidene fluoride, tetrafluoroethylene, and propylene; and copolymers of vinylidene fluoride and hexafluoropropylene.

In some cases, the binders can be crosslinked. Crosslinking can improve the mechanical properties of the binders and can improve the contact between the active material composition and any electrically conductive diluent that can be present. Other binders include polyimides such as the aromatic, aliphatic or cycloaliphatic polyimides described in U.S. Pat. Publ. No. 2006/0099506 (Krause et al.).

Additional useful binders can include lithium polyacrylate as disclosed in co-owned application U.S. Pat. Publ. No. 2008/0187838 (Le). Lithium polyacrylate can be made from poly(acrylic acid) that is neutralized with lithium hydroxide. In this application, poly(acrylic acid) includes any polymer or copolymer of acrylic acid or methacrylic acid or their derivatives where at least about 50 mole %, at least about 60 mole %, at least about 70 mole %, at least about 80 mole %, or at least about 90 mole % of the copolymer is made using acrylic acid or methacrylic acid. Useful monomers that can be used to form these copolymers include, for example, alkyl esters of acrylic or methacrylic acid that have alkyl groups with 1-12 carbon atoms (branched or unbranched), acrylonitriles, acrylamides, N-alkyl acrylamides, N,N-dialkylacrylamides, hydroxyalkylacrylates, and the like. Of particular interest are polymers or copolymers of acrylic acid or methacrylic acid that are water soluble—especially after neutralization or partial neutralization. Water solubility is typically a function of the molecular weight of the polymer or copolymer and/or the composition. Poly(acrylic acid) is very water soluble and is preferred along with copolymers that include significant mole fractions of acrylic acid. Poly(methacrylic) acid is less water soluble—particularly at larger molecular weights.

To make a positive or a negative electrode composite coating, the active powdered material, any selected additives such as binders, conductive diluents, fillers, adhesion promoters, thickening agents for coating viscosity modification such as carboxymethylcellulose (CMC) and other additives known by those skilled in the art are mixed in a suitable coating solvent such as water or N-methylpyrrolidinone (NMP) to form a coating dispersion or coating mixture. The dispersion can be mixed thoroughly and then applied to a foil current collector by any appropriate dispersion coating technique such as knife coating, notched bar coating, dip coating, spray coating, electrospray coating, or gravure coating. The slurry can be coated onto the current collector foil and then allowed to dry in air followed by drying in a heated oven, typically at about 80° C. to about 300° C. for about an hour to remove the solvent. Typical cathodes and anodes can be coated on both opposing sides of the current collector.

The provided lithium-ion electrochemical cells also include a charge-carrying electrolyte that can include a charge-carrying medium and an electrolyte salt. The electrolyte provides a charge-carrying pathway between the positive and negative electrodes, and initially contains at least the charge carrying media and the electrolyte salt. The electrolyte can include other additives that will be familiar to those skilled in the art. As will be appreciated by those skilled in the art, the electrolyte can be in any convenient form including liquids, gels and dry polymer.

A variety of charge carrying media can be employed in the electrolyte. Exemplary media are liquids or gels capable of solubilizing sufficient quantities of lithium salt and redox chemical shuttle so that a suitable quantity of charge can be transported from the positive electrode to negative electrode. Exemplary charge carrying media can be used over a wide temperature range, e.g., from about −30° C. to about 80° C. without freezing or boiling, and are stable in the electrochemical window within which the cell electrodes and shuttle operate. Representative charge carrying media include ethylene carbonate, propylene carbonate, dimethyl carbonate, diethyl carbonate, ethylmethyl carbonate, butylene carbonate, vinylene carbonate, fluoroethylene carbonate, vinylethylene carbonate, fluoropropylene carbonate, γ-butyrolactone, methyl difluoroacetate, ethyl difluoroacetate, dimethoxyethane, diglyme (bis(2-methoxyethyl) ether), and combinations thereof.

A variety of lithium salts can be employed in the electrolyte of lithium or lithium-ion cells. Exemplary lithium salts are stable and soluble in the chosen charge-carrying media, provide high ionic conductivity, and perform well with the chosen lithium-ion cell chemistry. These include LiPF₆, LiBF₄, LiClO₄, lithium bis(oxalato)borate (“LiBOB”), LiN(SO₂CF₃)₂, LiN(SO₂C₂F₅)₂, LiAsF₆, LiC(SO₂CF₃)₃, and combinations thereof. In other types of electrochemical cells, salts containing cations other than lithium can be employed, such as sodium, magnesium, aluminum, quaternary ammonium, dialkylimidazolium, alkylpyridinium, and dialkylpyrrolidinium.

A variety of electrolyte additives can also be employed to serve as passivating agents, gas suppression agents, stabilizers, or flame retardants, etc. These can typically be added to the formulated electrolyte in relatively low concentrations (less than 10 weight percent (wt %), less than 5 wt %, or less than 1 wt %) to improve the performance, stability and/or safety of the electrochemical cell. Common additives include but are not limited to VC (vinylene carbonate), ES (ethylene sulfite), FEC (fluoroethylene carbonate), 1,3-propenesultone, ethene sultone, 1,4-butene sultone, VEC (vinylethylene carbonate), CO₂, SO₂, 12-crown-4, 18-crown-6, catechol carbonate, α-bromo-γ-butyrolactone, methylchloroformate, 2-acetoxy-4,4,-dimethyl-4-butanolide, succinimide, methyl cinnamate. Additional electrolyte additives are described in U.S. Pat. No. 7,026,074 (Chen et al.) and U.S. Pat. Publ. No. 2007/0092802 (Ahn et al.). The electrolyte can also include a redox shuttle to prevent runaway thermal decomposition. Redox shuttles are well-known to those of ordinary skill in the art. Of particular importance may be triphenylamine redox shuttles such as those disclosed in U.S. Pat. No. 7,585,590 (Wang et al.); substituted phenothiazine redox shuttles such as those disclosed in U.S. Pat. No. 7,615,312 (Dahn et al.); N-oxide redox shuttles such as those disclosed in U.S. Pat. No. 7,615,317 (Dahn et al.); redox shuttles for overdischarge protection such as those disclosed in U.S. Pat. No. 7,648,801 (Dahn et al.) and aromatic compounds with at least one tertiary organic group and at least one alkoxy group such as those disclosed in U.S. Pat. No. 7,811,710 (Dahn et al.).

Objects and advantages of this invention are further illustrated by the following examples, but the particular materials and amounts thereof recited in these examples, as well as other conditions and details, should not be construed to unduly limit this invention.

### EXAMPLE

Thin film cathode electrodes for electrochemical tests were prepared as follows: 10 weight percent (wt %) polyvinylidene difluoride (PVDF, Aldrich Chemical Co.) in N-methyl pyrrolidinone (NMP, Aldrich Chemical Co.) solution was prepared by dissolving about 10 g PVDF into 90 g of NMP solution. A stock slurry was prepared by combining 7.33 g Super-P carbon (MMM Carbon, Belgium), 73.33 g of 10 wt % PVDF in NMP solution, and 200 g NMP in a glass jar and mixing by rolling. The mixed stock slurry contained about 2.6 wt % each of PVDF and Super-P carbon in NMP. 5.25 g of the stock slurry was mixed with 2.5 g cathode material (BC-618K, 3M Company, St. Paul, Minn.) using a Mazerustar mixer machine (Kurabo Industries Ltd., Japan) for 3 minutes to form uniform electrode slurry. The electrode slurry was then spread onto a thin aluminum foil on a glass plate using a 0.25 mm (0.010 in.) notch-bar spreader. The coated electrode was then dried in an 80° C. oven for 10 minutes. The electrode was then put into a 120° C. vacuum oven for 1 hour to evaporate NMP and moisture. The dry electrode contained about 90 wt % cathode material and 5 wt % PVDF and Super P each. The resulting coating weight was approximately 56 mg/cm², which corresponds to 8.62 mAh/cm² reversible capacity.

Lithium polyacrylate (LiPAA) was made by adding 60.41 g of 20 wt % aqueous lithium hydroxide to 100 g of 34 wt % aqueous poly(acrylic acid) (250,000 M_{W} available from Aldrich Chemicals, Milwaukee, Wis.) and diluting with 185.56 g of de-ionized water. This resulted in a 10 wt % aqueous solution of lithium polyacrylate (LiPAA) which had been 64% neutralized.

Anode composite particles were prepared by milling 2.813 g of silicon chips (Alfa Aesar, catalog no. 00311), 1.968 g of Co metal, and 0.219 g of graphite powder (MCMB-1028, MMM Carob, Belgium) with 28 tungsten carbide balls ( 5/16-inches each, approximately 108 grams) for 4 hours in a 45 milliliter tungsten carbide vessel using a SPEX MILL (Model 8000-D, Spex CertiPrep, Metuchen, N.J.) under an argon atmosphere. The vessel was then opened, chunks of caked powder were broken up, and the milling was continued for an additional hour in an argon atmosphere. The temperature of the tungsten carbide vessel was maintained at about 30° C. by air cooling.

Anodes comprising the anode composite particles, graphite (Timrex SLP30 (TimCal Ltd, Bodio, Switzerland) and LiPAA with a 62/32/6 weight ratio were made by placing 3.3 g of the composite particles, 1.7 g of Timrex SLP 30, 3.19 g of 10% aqueous 250 K molecular weight LiPAA and 1.5 g of water in a 45-milliliter stainless steel vessel with four tungsten carbide balls (12.75 mm diameter) and mixing in a planetary micro mill (PULVERISETTE 7, from Fritsch GmbH, Idon-Oberstein, Germany) at a speed setting of two for one hour. The resulting slurry was then coated onto a copper foil using a coating bar with a 0.2023 mm (0.008″) gap and dried under vacuum at 120° C. for one hour. The resulting coating weight was approximately 16 mg/cm² which corresponds to 8.38 mAh/cm² reversible capacity.

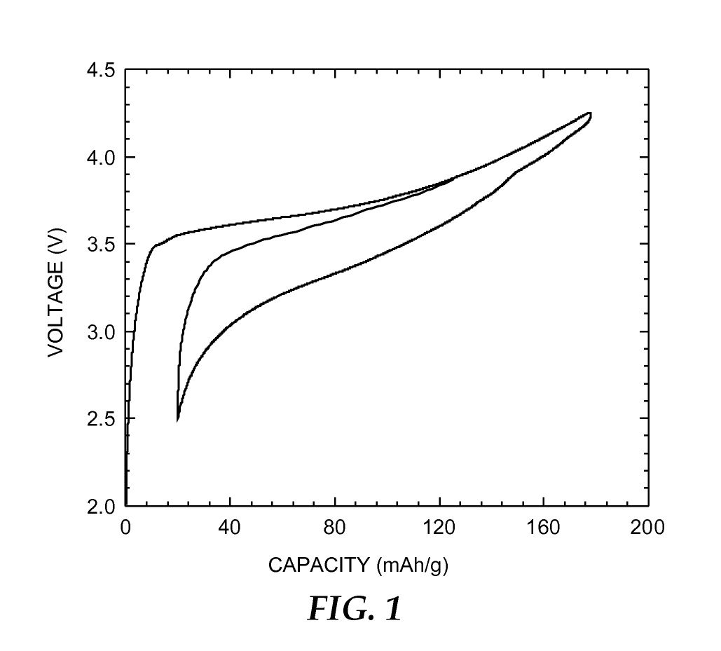

The electrodes described above served as a working electrodes in a 2325-type coin cell using a lithium foil (Aldrich) disk as a counter and reference electrode. Two layers of microporous polypropylene (PP) separator (CELGARD 2500) were used for each coin cell. The electrolyte used was 1 M LiPF₆ (Stella, Japan) in a solution of 90 wt % ethylene carbonate (EC):diethyl carbonate (DEC) (volume ratio 1:2, Grant Chemical Ferro Division) and 10 wt % fluoroethylene carbonate (FEC, Fujian Chuangxin, China). The coin cells were assembled and crimped closed in an argon-filled glove box. The cell was first charged to 4.25V at a rate of C/20 and held at 4.25V until the rate fell to a value of C/40. The cell was then discharged to 2.5V at a C/20 rate. For subsequent cycles, the cell was charged at a rate of C/10 to 4.25V and held at 4.25V until the rate fell to a value of C/20 and then discharged to 2.5V at a C/10 rate. The C/20 rate corresponded to 0.82 mA. The voltage curve (FIG. 1) showed a reversible capacity corresponding to a reversible specific cathode capacity of 158 mAh/g or a cathode utilization of 97.5%.

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows. All references cited in this disclosure are herein incorporated by reference in their entirety.

Following are exemplary embodiments of high capacity alloy anodes and lithium-ion electrochemical cells containing same, respectively, according to aspects of the present invention.

Embodiment 1 is a lithium-ion electrochemical cell comprising: a cathode that includes an electrochemically-active metal oxide coating on a first current collector; an electrolyte; and an anode that includes an electrochemically-active alloy coating on a second current collector, wherein both the anode and the cathode have an electrode loading of greater than about 4.5 mAh/cm² per coated side.

Embodiment 2 is a lithium-ion electrochemical cell according to embodiment 1, wherein both the anode and cathode have an electrode loading of greater than about 6 mAh/cm² per coated side.

Embodiment 3 is a lithium-ion electrochemical cell according to embodiment 1, wherein both the anode and cathode have an electrode loading of greater than about 8 mAh/cm² per coated side.

Embodiment 4 is a lithium-ion electrochemical cell according to embodiment 1, wherein the electrochemically-active alloy comprises silicon or tin.

Embodiment 5 is a lithium-ion electrochemical cell according to embodiment 1, wherein the electrochemically-active metal oxide coating comprises cobalt, manganese, or nickel.

Embodiment 6 is a lithium-ion electrochemical cell according to embodiment 1, wherein the electrochemically-active metal oxide coating comprises cobalt, manganese and nickel.

Embodiment 7 is a lithium-ion electrochemical cell according to embodiment 1, wherein at least one of the electrochemically-active metal oxide coating or the electrochemically-active alloy coating comprises a binder, a conductive diluent, or both.

Embodiment 8 is a lithium-ion electrochemical cell according to embodiment 7, wherein the binder comprises lithium polyacrylate.

Embodiment 9 is a lithium-ion electrochemical cell according to embodiment 1, wherein the first current collector comprises aluminum and has two opposing sides.

Embodiment 10 is a lithium-ion electrochemical cell according to embodiment 1, wherein the second current collector comprises copper and has two opposing sides.

Embodiment 11 is a lithium-ion electrochemical cell according to embodiment 9, wherein the first current collector comprises an electrochemically-active alloy coating on both opposing sides of the second current collector.

Embodiment 12 is a lithium-ion electrochemical cell according to embodiment 1, wherein the cathode has a coating weight of the electrochemically-active metal oxide coating of greater than about 30 mg/cm².

Embodiment 13 is a lithium-ion electrochemical cell according to embodiment 1, wherein the electrode loading of the cathode is within 15% of the electrode loading of the anode.

Embodiment 14 is a method of making a lithium-ion electrochemical cell comprising: providing a cathode and includes an electrochemically-active metal oxide coating on a first current collector, an anode that includes an electrochemically-active alloy coating on a second current collector, and an electrolyte; and assembling the cathode, the anode, and the electrolyte to form an lithium-ion electrochemical cell, wherein the electrode loadings of both the cathode and the anode are greater than about 4.5 mAh/cm² per coated side.

Embodiment 15 is a method of making a lithium-ion electrochemical cell according to embodiment 14, wherein the electrode loadings of both the cathode and the anode are greater than about 6 mAh/cm² per coated side.

Embodiment 16 is a method of making a lithium-ion electrochemical cell according to embodiment 15, wherein the electrode loadings of both the cathode and the anode are greater than about 8 mAh/cm² per coated side.

Embodiment 17 is a method of making a lithium-ion electrochemical cell according to embodiment 14, wherein the electrochemically-active alloy coating comprises lithium polyacrylate.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the mechanical, electro-mechanical, and electrical arts will readily appreciate that the present invention may be implemented in a very wide variety of embodiments. This application is intended to cover any adoptions or variations of the preferred embodiments discussed herein. Therefore, it is manifestly intended that this invention be limited only by the claims and the equivalents thereof.

1. A lithium-ion electrochemical cell comprising:
a cathode that includes an electrochemically-active metal oxide coating on a first current collector;
an electrolyte; and
an anode that includes an electrochemically-active alloy coating on a second current collector,
wherein both the anode and the cathode have an electrode loading of greater than about 4.5 mAh/cm² per coated side.

2. A lithium-ion electrochemical cell according to claim 1, wherein both the anode and cathode have an electrode loading of greater than about 6 mAh/cm² per coated side.

3. A lithium-ion electrochemical cell according to claim 1, wherein both the anode and cathode have an electrode loading of greater than about 8 mAh/cm² per coated side.

4. A lithium-ion electrochemical cell according to claim 1, wherein the electrochemically-active alloy comprises silicon or tin.

5. A lithium-ion electrochemical cell according to claim 1, wherein the electrochemically-active metal oxide coating comprises cobalt, manganese, or nickel.

6. A lithium-ion electrochemical cell according to claim 1, wherein the electrochemically-active metal oxide coating comprises cobalt, manganese and nickel.

7. A lithium-ion electrochemical cell according to claim 1, wherein at least one of the electrochemically-active metal oxide coating or the electrochemically-active alloy coating comprises a binder, a conductive diluent, or both.

8. A lithium-ion electrochemical cell according to claim 7, wherein the binder comprises lithium polyacrylate.

9. A lithium-ion electrochemical cell according to claim 1, wherein the first current collector comprises aluminum and has two opposing sides.

10. A lithium-ion electrochemical cell according to claim 1, wherein the second current collector comprises copper and has two opposing sides.

11. A lithium-ion electrochemical cell according to claim 10, wherein the second current collector comprises an electrochemically-active alloy coating on both opposing sides of the second current collector.

12. A lithium-ion electrochemical cell according to claim 1, wherein the cathode has a coating weight of the electrochemically-active metal oxide coating of greater than about 30 mg/cm².

13. A lithium-ion electrochemical cell according to claim 1, wherein the electrode loading of the cathode is within 15% of the electrode loading of the anode.

14. A method of making a lithium-ion electrochemical cell comprising:
providing a cathode and includes an electrochemically-active metal oxide coating on a first current collector, an anode that includes an electrochemically-active alloy coating on a second current collector, and an electrolyte; and
assembling the cathode, the anode, and the electrolyte to form an lithium-ion electrochemical cell,
wherein the electrode loadings of both the cathode and the anode are greater than about 4.5 mAh/cm² per coated side.

15. A method of making a lithium-ion electrochemical cell according to claim 14, wherein the electrode loadings of both the cathode and the anode are greater than about 6 mAh/cm² per coated side.

16. A method of making a lithium-ion electrochemical cell according to claim 15, wherein the electrode loadings of both the cathode and the anode are greater than about 8 mAh/cm² per coated side.

17. A method of making a lithium-ion electrochemical cell according to claim 14, wherein the electrochemically-active alloy coating comprises lithium polyacrylate.
